(19) United States
(12) Patent Application Publication
(10) Pub. No.: US 2008/0030803 A1
(43) Pub. Date: Feb. 7, 2008

(54) Image sensor for improving image quality and image sensing method using the same

(75) Inventors: Dong Ki Min, Seoul (KR); Seung Bum Hong, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/707,139

(22) Filed: Feb. 16, 2007

(30) Foreign Application Priority Data
Aug. 2, 2006 (KR) 10-2006-0073048

(51) Int. Cl. H04N 1/387

(52) U.S. Cl. 358/483

(57) ABSTRACT

Provided are an image sensor for improving image quality and an image sensing method using the same, which can improve the quality of a sensed image without changing resolution of a color filter array and a photoelectric conversion semiconductor device for sensing an image. The image sensor for improving image quality includes: a scanner unit movable on a plane; a color filter array fixed on the scanner unit; and a photoelectric conversion semiconductor device including a plurality of pixels aligned beneath the color filter array.

### CROSS-REFERENCE TO RELATED APPLICATION

This application claims priority from Korean Patent Application No. 10-2006-0073048 filed on Aug. 2, 2006 in the Korean Intellectual Property Office, the disclosure of which is incorporated herein by reference in its entirety.

### BACKGROUND OF THE INVENTION

1. Field of the Invention

The present invention relates to an image sensor and an image sensing method for image quality improvement, and more particularly to an image sensor for improving image quality and an image sensing method using the same, which can improve the quality of a sensed image without changing resolution of a color filter array and a photoelectric conversion semiconductor device for sensing an image.

2. Description of the Prior Art

As is generally known in the art, an image sensor converts one or more dimensional optical information into electrical signals. In the image sensor, photoelectric conversion semiconductor devices for converting an optical image into an electrical signal by using a semiconductor substrate are classified into two types, that is, a metal oxide semiconductor (MOS) type and a charge-coupled device (CCD) type.

A complementary metal oxide semiconductor (CMOS) image sensor is a device for converting an optical image into an electrical signal by using CMOS semiconductor technology, in which a number of MOS transistors equal to the number of pixels are constructed, and a switching operation of detecting outputs of the MOS transistors one by one is employed. As compared with the CCD image sensor widely used in the prior art, the CMOS image sensor has advantages in that the operational method thereof is simple, various scanning modes can be realized, and products can be miniaturized because a signal processing circuit can be integrated in a single chip.

Recently, various multimedia devices, such as a portable phone, a personal digital assistant (PDA), etc., have been equipped with apparatuses for photographing and/or displaying an image, in which a small camera module has been used as an image input device. With the users' desire for an image of a higher quality in these devices, it has been required to increase the resolution of an image sensor used as the image input device.

FIG. 1 is a perspective view of a conventional image sensor which senses an image through photoelectric conversion.

As shown in FIG. 1, the conventional image sensor includes a photoelectric conversion semiconductor device 10, a color filter array 20, and a microlens array 30.

The photoelectric conversion semiconductor device 10 is fixed to the top of a scanner, and includes a plurality of pixels aligned over the front surface of the photoelectric conversion semiconductor device 10. Each pixel of the photoelectric conversion semiconductor device 10 is a light receiving unit, and generates a signal charge corresponding to the intensity of light which is incident to the corresponding pixel.

The color filter array 20 forms color digital images, in which, for example, one of red, green, and blue filters is aligned with the pixels of the photoelectric conversion semiconductor device 10 in one-to-one correspondence. The color filter array 20 is constructed on the top of the light receiving units of the photoelectric conversion semiconductor device 10 through a lithography process or the like.

The microlens array 30 includes a plurality of lenses, for example, hemispheric microlenses 31, which are two-dimensionally aligned and stacked on the top of the color filter array 20. The lenses of the microlens array 30 are disposed with the color filter array 20 in such a manner that the lenses are aligned with pixels so as to increase the intensity of light incident to the light receiving units of the photoelectric conversion semiconductor device 10.

The conventional image sensor having such a construction obtains image data corresponding to each color through the color filter array which is partitioned into red, green, and blue filters, and restores an original image from the obtained image data by using an algorithm called “demosaic”. However, although various methods have been proposed to restore an original image, the conventional methods cause a distortion such as aliasing in such a restoring process, thereby degrading image quality.

An image sensor of a new construction for preventing degradation of image quality, which is caused because the color filter array senses color data divided according to colors, is disclosed in U.S. Pat. No. 5,965,875. According to the image sensor of the new construction, light of an incident image is sensed according to wavelengths by using a photoelectric conversion semiconductor device of a vertical structure, so as to reduce an error in restoring by demosaic. However, such an image sensor has problems in that the manufacturing process for the photoelectric conversion semiconductor device is complicated, and a degree of color separation by the vertical structure is lower than that of a color filter, thereby being a limitation in solving the problem of image quality degradation.

### SUMMARY OF THE INVENTION

Accordingly, exemplary embodiments of the present invention have been made to solve the above-mentioned problems occurring in the prior art, and an object of the present invention is to provide an image sensor which can improve quality of a sensed image while keeping the structures of the conventional photoelectric conversion semiconductor device and color filter array as they are.

Another object of the present invention is to provide an image sensing method using the image sensor for improving image quality, which can easily improve the quality of an image sensed by the image sensor.

In order to accomplish these objects, there is provided an image sensor for improving image quality, the image sensor sensing an image through photoelectric conversion, the image sensor including a scanner unit movable on a plane; a color filter array fixed on the scanner unit; and a photoelectric conversion semiconductor device including a plurality of pixels aligned beneath the color filter array.

The image sensor may further include a microlens array formed on top of the color filter array so as to correspond to the pixels, the microlens array condensing light.

Herein, the scanner unit is fixed on an end of the color filter array so as to move with the color filter array.

Also, the scanner unit may move interval by interval between the pixels in a horizontal or vertical direction with respect to a transverse direction in which the pixels are aligned.

Also, the color filter array may include color filters having different colors, in which the color filters are aligned in a pattern of stripes.

In accordance with another aspect of the present invention, there is provided an image sensing method using an image sensor for sensing an image through photoelectric conversion, the method including the steps of: (a) allowing a photoelectric conversion semiconductor device to sense light incident through a color filter array which is stationary; (b) storing data of an image sensed by the photoelectric conversion semiconductor device; (c) moving the color filter array on a plane by the scanner unit; (d) allowing the photoelectric conversion semiconductor device to sense light incident through the color filter array which is stopped after moving; (e) storing data of another image sensed by the photoelectric conversion semiconductor device; (f) repeating steps (c) to (e); and (g) comparing and analyzing the data stored according to movement of the color filter array so as to obtain data of a resultant image having improved image quality.

In an exemplary embodiment, the color filter array may move interval by interval between pixels of the photoelectric conversion semiconductor device, in a horizontal or vertical direction on the plane, with respect to a transverse direction in which the pixels are aligned.

Herein, the color filter array can include filters of different colors, in which the filters have a pattern of stripes, and the color filter array moves only in a direction perpendicular to the pattern of stripes.

### BRIEF DESCRIPTION OF THE DRAWINGS

The above and other aspects of the present invention will be more apparent from the following detailed description taken in conjunction with the accompanying drawings, in which:

FIG. 1 is a perspective view of a conventional image sensor which senses an image through photoelectric conversion;

FIG. 2 is a perspective view of an image sensor for improving image quality according to an exemplary embodiment of the present invention;

FIG. 3 is a partial plan view illustrating the alignment of a color filter array shown in FIG. 2;

FIG. 4 is a cross-sectional view illustrating an image sensor for improving image quality according to another exemplary embodiment of the present invention, in which only a photoelectric conversion semiconductor device moves;

FIG. 5 is a perspective view illustrating an image sensor for improving image quality according to still another exemplary embodiment of the present invention, in which a color filter array and a photoelectric conversion semiconductor device move together;

FIG. 6 is a flowchart illustrating an image sensing method using the image sensor according to an embodiment of the present invention;

FIG. 7 is a plan view illustrating the locations through which the color filters having a pattern of stripes, shown in FIG. 3, consecutively moves;

FIG. 8 is a view marking positions for discriminating between pieces of image data sensed according to the movement of the color filters shown in FIG. 7;

FIG. 9 is a view illustrating the change of a color filter used to correspond to each position marked in FIG. 8 in a time sequence;

FIGS. 10A to 10D are cross-sectional views illustrating location change of color filters with respect to incident light, depending on the movement of the color filters shown in FIG. 7;

FIGS. 11A to 11D are plan views illustrating the arrangement of color filters resulting from consecutive movement of a color filter array aligned in a mosaic pattern, when the image sensing method according to exemplary embodiments of the present invention are applied to an image sensor including the color filter array;

FIG. 12 is a view of an original image used in a simulation and a partial enlarged view of region ‘A’ of the original image;

FIG. 13 is a view of an image obtained by sensing the original image of FIG. 12 by a conventional image sensing method;

FIG. 14 is a view of a resultant image obtained by the image sensing method using a color filter array having a pattern of stripes according to exemplary embodiments of the present invention; and

FIG. 15 is a plan view illustrating alignment of a mosaic color filter array used when the image of FIG. 13 was obtained.

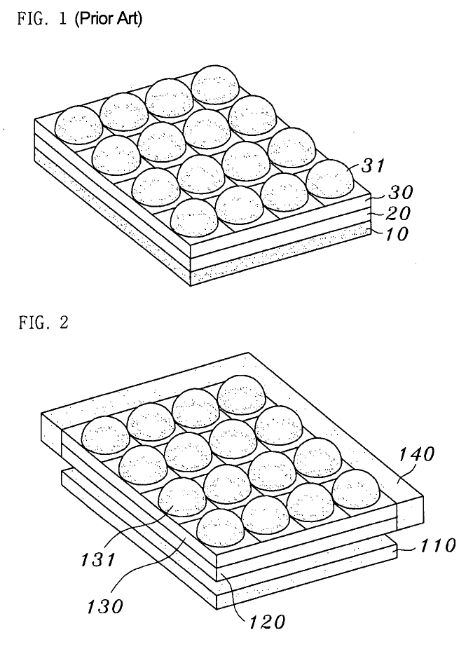

### DETAILED DESCRIPTION OF EXEMPLARY EMBODIMENTS OF THE PRESENT INVENTION

Hereinafter, exemplary embodiments of the present invention will be described with reference to the accompanying drawings.

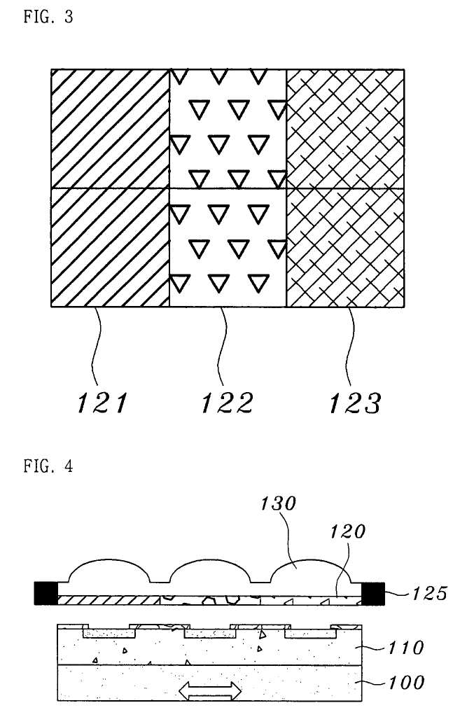

FIG. 2 is a perspective view of an image sensor for improving image quality according to an exemplary embodiment of the present invention, and FIG. 3 is a partial plan view illustrating the alignment of a color filter array shown in FIG. 2.

As shown in FIG. 2, the image sensor for improving image quality according to an exemplary embodiment of the present invention includes a scanner unit 140, a color filter array 120, and a photoelectric conversion semiconductor device 110. In this case, it is preferred that a microlens array 130 is formed on the top of the color filter array 120.

The scanner unit 140, which is a supporter moving on one plane, acts as a supporter capable of fixedly mounting the color filter array 120 by connecting an end of the scanner unit 140 to the color filter array 120. The scanner unit 140 may be connected to an external controller so as to, by means of software, be moved by a predetermined distance in a vertical or horizontal direction together with the color filter array 120 fixed to the scanner unit 140.

Also, the scanner unit 140 may be highly precise so as to enable the scanner unit 140 to move interval by interval between neighboring pixels in the photoelectric conversion semiconductor device 110, so that the color filter array 120 can move interval by interval between neighboring pixels according to the movement of the scanner unit 140. In this case, the color filter array 120 may be constructed to be movable only in the horizontal or vertical direction with respect to a transverse direction in which the pixels are aligned.

The color filter array 120 forms color digital images of a sensed object, in which, for example, one of a red filter 121, a green filter 122, and a blue filter 123 is aligned with the pixels of the photoelectric conversion semiconductor device 110 in one-to-one correspondence. Light passing through each color filter is sensed by a light receiving unit of the photoelectric conversion semiconductor device 110, so that an image of the color corresponding to each color filter through which light has passed is sensed.

According to movement of the scanner unit 140, the color filter array 120 may move interval by interval between pixels so as to change the color filter (i.e., color) corresponding to each pixel position so that an image of a different color corresponding to a changed color filter can be sensed. Since the color of a color filter corresponding to each pixel position changes, as described above, not only an image of a predetermined color but also images of different colors are sensed.

Also, images of multiple colors are sensed while the location of the color filters changes as described above, and then data of the images obtained based on these colors are comparatively analyzed through image processing and combined with each other, thereby obtaining improved image quality.

Also, since it is unnecessary to consider the conventional complicated alignment of color filters in the color filter array 120 when images based on colors is sensed while the color filter array 120 moves, the color filter array 120 used in the image sensor for improving image quality according to exemplary embodiments of the present invention can be constructed such that filters of different colors are aligned in a pattern of stripes, as shown in FIG. 3. The color filter array 120 aligned in a pattern of stripes as described above has an advantage in that it can be more easily manufactured with a fine pattern, as compared with a color filter array used in the conventional image sensor.

The photoelectric conversion semiconductor device 110 is formed beneath the color filter array 120, and includes a plurality of pixels aligned with the color filter array 120. Each of the pixels aligned over the front surface of the photoelectric conversion semiconductor device 110 is a light receiving unit for sensing light, and generates a signal charge corresponding to the intensity of light which is incident to the corresponding pixel. The photoelectric conversion semiconductor device 110 may include a metal oxide semiconductor-type (MOS-type) solid-state imaging device and a charge-coupled device-type (CCD-type) solid-state imaging device.

The microlens array 130 includes a plurality of lenses, for example, hemispheric microlenses 131, which are two-dimensionally aligned and stacked on the top of the color filter array 120. The microlens array 130 is disposed with the color filter array 120 in such a manner that the lenses are aligned with pixels so as to increase the intensity of light incident to the light receiving units of the photoelectric conversion semiconductor device 110.

According to the image sensor for improving image quality based on the present invention, after the scanner unit 140 moves the color filter array 120 fixed to the scanner unit 140, first image data obtained by the photoelectric conversion semiconductor device 110 through the color filter array 120 before the movement and second image data obtained by the photoelectric conversion semiconductor device 110 through the color filter array 120 after the movement are combined and corrected through image processing, so that data of a resultant image having improved image quality can be obtained.

In this case, since the color filter array 120 moved by the scanner unit 140 moves interval by interval between neighboring pixels of the photoelectric conversion semiconductor device 110, different image data through a color filter of a different color, which have not been sensed by the color filter array 120 before movement, are additionally obtained with respect to the same position after the movement.

The image sensors for improving image quality, which have different constructions according to other exemplary embodiments of the present invention, will now be described.

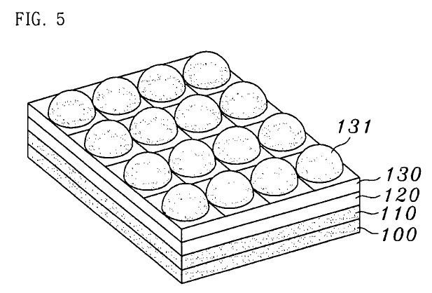

FIG. 4 is a cross-sectional view illustrating an image sensor for improving image quality according to another exemplary embodiment of the present invention in which only a photoelectric conversion semiconductor device moves, and FIG. 5 is a perspective view illustrating an image sensor for improving image quality according to still another exemplary embodiment of the present invention in which a color filter array and a photoelectric conversion semiconductor device move together.

Referring to FIG. 4, the image sensor for improving image quality according to another exemplary embodiment of the present invention includes a photoelectric conversion semiconductor device 110 fixed on a scanner unit 100 moving on one plane, and a color filter array 120 fixed by a holder 125. Also, a microlens array 130 is formed on the top of the color filter array 120.

According to such a construction, while the position of the color filter array 120 is fixed, the photoelectric conversion semiconductor device 110 moves interval by interval between neighboring pixels by the scanner unit 100. In this case, similar to the above-mentioned exemplary embodiment of the present invention, the photoelectric conversion semiconductor device 110 combines and corrects, through image processing, first image data obtained by the photoelectric conversion semiconductor device 110 through the color filter array 120 before movement and second image data obtained by the photoelectric conversion semiconductor device 110 through the color filter array 120 after the movement, so that data of a resultant image having improved image quality can be obtained.

Referring to FIG. 5, the image sensor for improving image quality according to still another exemplary embodiment of the present invention includes a photoelectric conversion semiconductor device 110 fixed on a scanner unit 100 moving on one plane, and a color filter array 120 and a microlens array 130 which are sequentially and fixedly formed on the photoelectric conversion semiconductor device 110. In this case, the microlens array 130 includes hemispheric microlenses 131 so as to increase the intensity of incident light.

According to still another exemplary embodiment of the present invention, the photoelectric conversion semiconductor device 110 is formed on the scanner unit 100 movable interval by interval between neighboring pixels, and the color filter array 120 is formed on the top of the photoelectric conversion semiconductor device 110, so that it is possible to move the color filter array 120 interval by interval between neighboring pixels by moving the scanner unit 100. Accordingly, a color filter (i.e., color) corresponding to light incident to a predetermined position changes according to movement of the scanner unit 100, thereby giving the same effect as the image sensor according to the above-mentioned exemplary embodiment of the present invention.

Hereinafter, an image sensing method using an image sensor for improving image quality according to an exemplary embodiment of the present invention, which has a resolution improvement effect, will be described.

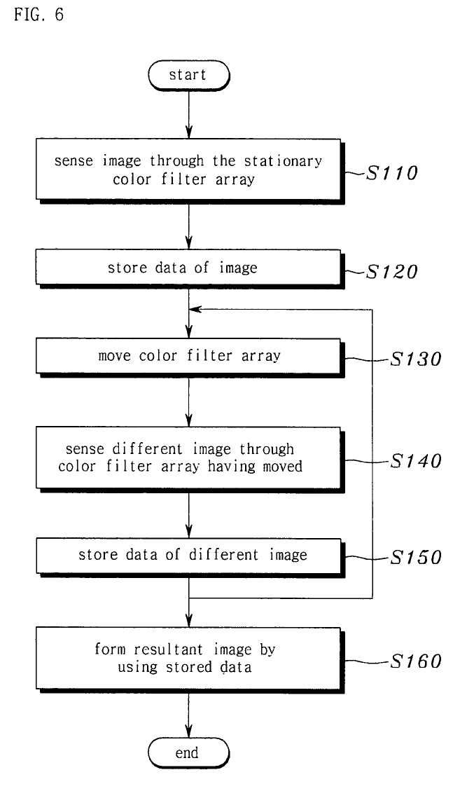

FIG. 6 is a flowchart illustrating an image sensing method using the image sensor according to an exemplary embodiment of the present invention.

As shown in FIG. 6, according to an image sensing method using the image sensor which senses an image through photoelectric conversion, light incident through the stationary color filter array is sensed as a first image through a plurality of pixels of the photoelectric conversion semiconductor device which are aligned with the color filter array (S110). In this case, data of the first image correspond to an electric signal, into which the intensity of light (i.e., the intensity of an optical signal) incident to the light receiving unit of the photoelectric conversion semiconductor device is converted. The data of the first image are obtained together with color data, by each color of the color filter array which corresponds to each pixel.

The data of the first image obtained as described above are stored in the data storage unit of an image photographing device, such as a digital camera, by an external controller (S120).

Then, the scanner unit connected to the color filter array moves on one plane, so that the color filter array moves on the same plane or on a different plane according to the movement of the scanner unit (S130). In this case, the scanner unit may move on the plane in a horizontal or vertical direction with respect to a transverse direction in which the pixels are aligned, and the scanner unit moves by the distance between neighboring pixels of the photoelectric conversion semiconductor device.

When the color filter array moves on the plane by the distance between neighboring pixels, a color filter (i.e., color) of the color filter array corresponding to a position on which light for the same image is incident, changes. For example, a filter corresponding to a predetermined position changes from a red filter to a green filter.

Herein, in order to move the color filter array, as described above, it will do if the image sensor for improving image quality has a construction which enables the color filter array to move according to movement of the scanner unit, such as a construction in which the scanner unit is fixed on an end of the color filter array, or a construction in which the photoelectric conversion semiconductor device and color filter array are sequentially formed on the scanner unit. That is, the construction of the image sensor can be variously modified, on the condition that the color filter array can move.

Since the movement distance of the color filter array is equal to the distance between pixels, light incident to an equal position is sensed in a state where only a color filter (i.e., color) is changed without any change in the other conditions. Accordingly, under a condition that a color filter (i.e., color) of the color filter array which has moved is changed, light incident through the color filter array is sensed as a second image through a plurality of pixels of the photoelectric conversion semiconductor (S140). Then, the sensed second image is separately stored in the data storage unit, which has stored the data of the first image obtained before the movement (S150).

Consequently, the data of the first and second images correspond to data sensed by the photoelectric conversion semiconductor device when light incident to an equal position passes through each of two color filters having different colors, respectively, thereby obtaining data based on an additional color which was unobtainable in the conventional image sensing method.

In order to more improve image resolution, after the data of the second image has been stored in the data storage unit, the scanner unit again may move the color filter array by the distance between pixels, and thus light incident to an equal position is sensed as a third image by the photoelectric conversion semiconductor device via a color filter having still anther color. In this case, data of the third image are additionally stored in the data storage.

Through repetition of such a procedure, data of an image with respect to all colors of color filters at an equal position are consecutively stored.

In this case, when the color filter array has a structure in which filters of different colors are aligned in a pattern of stripes, the color filter array may move perpendicularly to the stripes. While the color filter array having a pattern of stripes is moving perpendicularly to the stripes interval by interval between pixels, the photoelectric conversion semiconductor device senses data of an image with respect to each case in which the same light passes through a red, green, or blue filter.

The movement of the color filter array having the pattern of stripes will be described below.

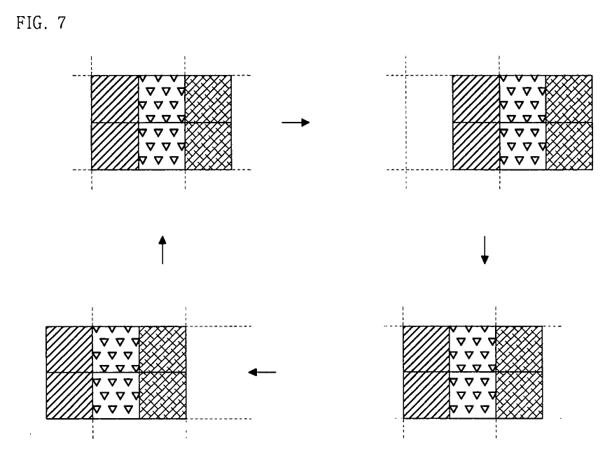

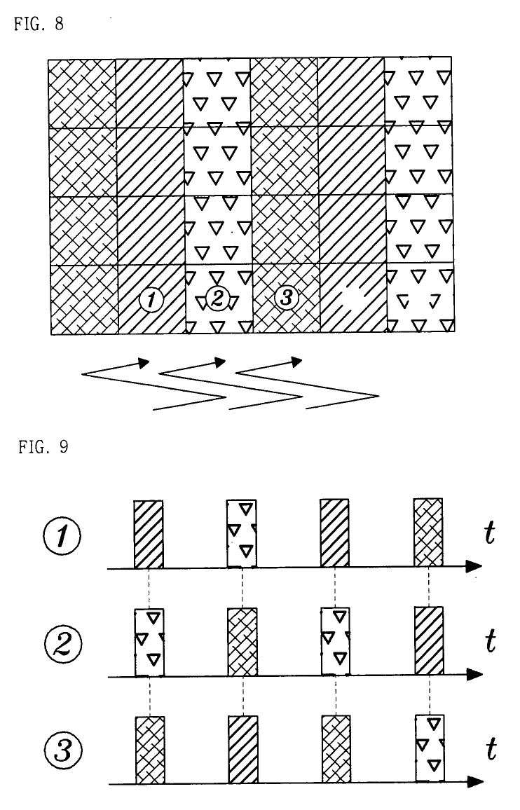

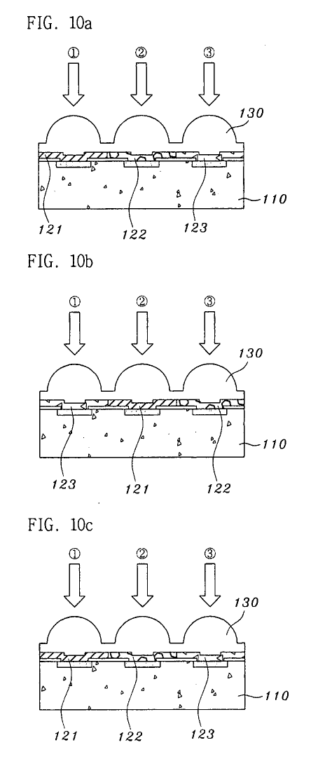

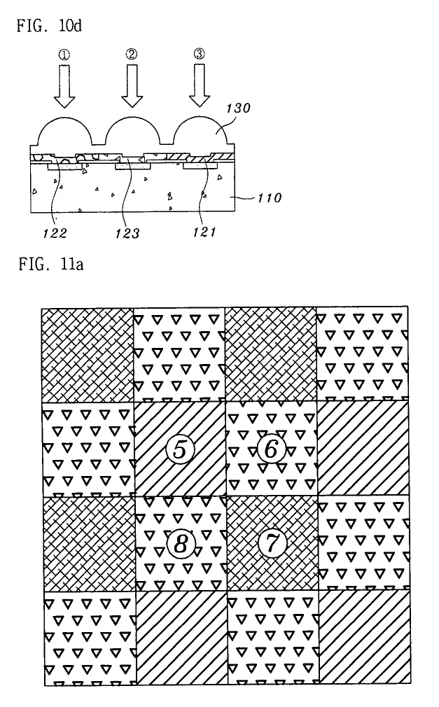

FIG. 7 is a plan view illustrating the locations through which the color filters having a pattern of stripes, shown in FIG. 3, consecutively moves, FIG. 8 is a view marking positions for discriminating between pieces of image data sensed according to the movement of the color filters shown in FIG. 7, and FIG. 9 is a view illustrating the change of a color filter used to correspond to each position marked in FIG. 8 in a time sequence. FIGS. 10A to 10D are cross-sectional views illustrating location change of color filters with respect to incident light, depending on the movement of the color filters shown in FIG. 7. The components having the same construction and function are indicated with the same reference numerals in the drawings.

As shown in FIGS. 7, 8, and 10A to 10D, for example, while the color filter array is located at an initial location on the basis of dotted lines indicated in FIG. 7, moves one time by a predetermined distance to the left, and then moves two times in the unit of predetermined distance to the right, light passing through each of the color filters 121, 122, and 123 via the microlens array 130 for each position may be sensed by the pixels of the photoelectric conversion semiconductor device 110. In this case, when the color filter array moves one time by the distance between the pixels to the right and then again moves by the distance between the pixels to the left, the color filter array rightly returns to it original location prior to the movement. In addition, various movement methods may be employed to enable a pixel of each position to sense light passing through each of the red filter 121, green filter 122, and blue filter 123.

In order to sense an image which has passed through each of color filters for each color while the color filter array moves as described above, when the color filter array moves, for example, according to the method as described with reference to FIGS. 7, 10A to 10D, a color filter used for each of positions \textcircled{1}, \textcircled{2}, and \textcircled{3} is changed in a sequence shown in FIG. 9.

Color data sensed through a color filter corresponding to each position by the photoelectric conversion semiconductor device 110 may be calculated by Equation 1. Herein, “C₁”, “C₂”, and “C₃” represents color data of images corresponding to positions \textcircled{1}, \textcircled{2}, and \textcircled{3}, respectively, “k” represents a position, and “k1”, “k2”, “k3”, and “k4” represent a sequence corresponding to the number of times that color filters move based on each position. Also, “r”, “g”, and “b” represent sensitivity data of an image obtained when light incident through each of the red, green, and blue filters is sensed by each pixel according to colors of each passed color filter, respectively.

Therefore, sensitivity data sensed through each of the red, green, and blue filters according to each of the number of movement times may be expressed as color data as shown in Equation 1.

$${C}_{1} ( k ) = \frac{r ( {k}_{1} ) + r ( {k}_{3} )}{2} + g ( {k}_{2} ) + b ( {k}_{4} ) \\ {C}_{2} ( k ) = \frac{g ( {k}_{1} ) + g ( {k}_{3} )}{2} + b ( {k}_{2} ) + r ( {k}_{4} ) \\ {C}_{3} ( k ) = \frac{b ( {k}_{1} ) + b ( {k}_{3} )}{2} + r ( {k}_{2} ) + g ( {k}_{4} ) \qquad Equation 1$$

For example, data stored in a table according to the movement of the color filter array are comparatively analyzed through image processing, for example, using a mathematical algorithm as expressed in Equation 1, thereby obtaining data of a resultant image having improved image quality (S160 of FIG. 6).

The following description will be given with respect to an image sensing method using an image sensor according to exemplary embodiments of the present invention when the color filters of the color filter array are aligned in a mosaic pattern.

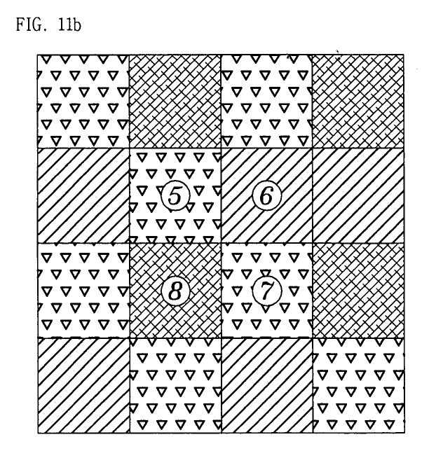

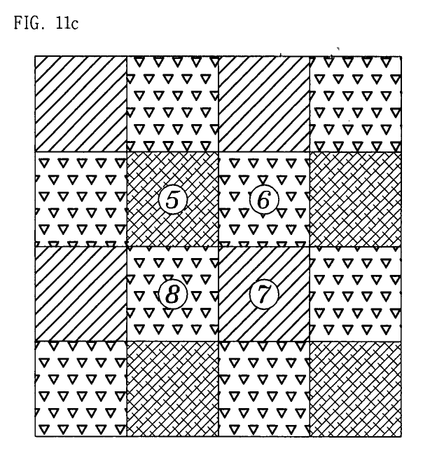

FIGS. 11A to 11D are plan views illustrating the arrangement of color filters resulting from consecutive movement of a color filter array aligned in a mosaic pattern, when the image sensing method according to exemplary embodiments of the present invention is applied to an image sensor including the color filter array.

As shown in FIGS. 11a to 11d, while the color filter array, for example, moves one time to the left side (i.e., in the positive horizontal direction) from an initial location, moves one time downward (i.e., in the negative vertical direction), and then moves one time to the right side (i.e., in the negative horizontal direction), light passing through each color filter via the microlens array based on each position may be sensed by the pixels of the photoelectric conversion semiconductor device.

In this case, when positions of pixels through which each incident light passes are sequentially assigned with \textcircled{5}, \textcircled{6}, \textcircled{7}, and \textcircled{8}, the color filter or image sensor moves by the distance between the pixels in each movement direction. Thereafter, when the color filter array moves one time upward (i.e., in the positive vertical direction), the color filter array returns to the initial location.

For example, the image obtained through the color filter at position \textcircled{5} corresponds to an image having passed one time through a red filter, two times through a green filter, and one time through a blue filter, in the same manner as color filters corresponding to position \textcircled{2} in FIG. 8. With respect to the remaining positions \textcircled{6}, \textcircled{7}, and \textcircled{8}, it is possible to calculate proper color data according to each position by using the same manner as described with reference to Equation 1.

Therefore, data stored according to movement of the color filter array are comparatively analyzed by means of image processing using a mathematical algorithm which can be applied in the same manner as Equation 1 according to the movement pattern and the number of movement times of the color filter array, thereby obtaining data of a resultant image having improved image quality.

The following description will be given with respect to a result of a simulation for showing an effect of the image sensing method using the image sensor according to an exemplary embodiment of the present invention.

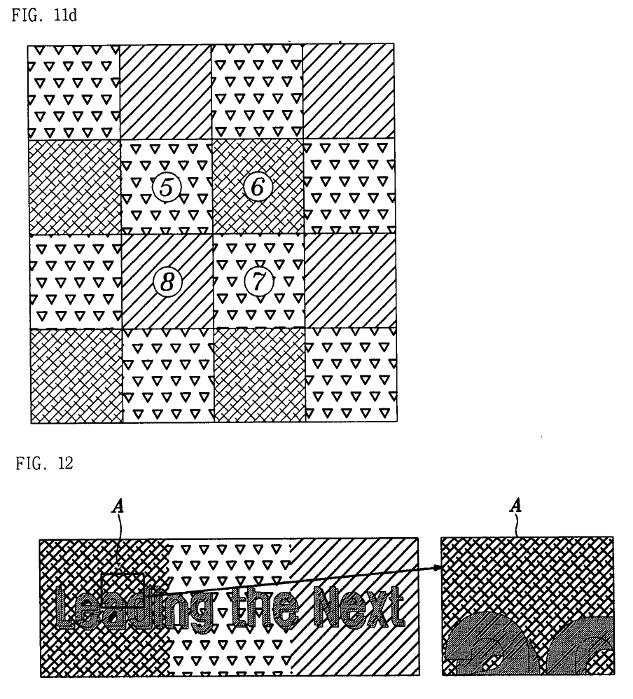

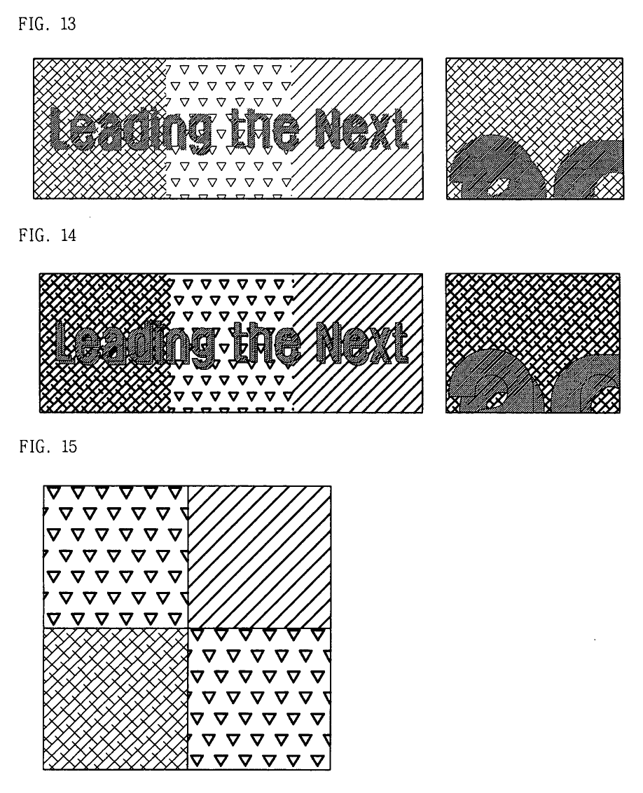

FIG. 12 is a view of an original image used in a simulation and a partial enlarged view of region ‘A’ of the original image, and FIG. 13 is a view of an image obtained by sensing the original image of FIG. 12 in a bilinear demosaic manner using a Bayer color pattern, which is a conventional image sensing method. FIG. 14 is a view of an image obtained by sensing the original image of FIG. 12 by means of the image sensing method using a color filter array having a pattern of stripes according to an exemplary embodiment of the present invention, in which the color filter array moves in the sequence shown in FIG. 7. FIG. 15 is a plan view illustrating alignment of a mosaic color filter array used when the image of FIG. 13 was obtained.

Referring to FIGS. 12 to 15, when partially embodied portions are compared with each other, it can be understood by FIG. 13 that an image obtained by the conventional image sensing method has a much lower resolution than that of the original image shown in FIG. 12. In contrast, it can be understood that an image of FIG. 14 obtained by the image sensing method of an exemplary embodiment of the present invention is almost identical to the original image of FIG. 12 to a degree by which it is impossible to find any differences between the two images.

Also, when a result obtained by the conventional method of FIG. 13 and a result obtained by the method of the present invention of FIG. 14 are numerically compared with each other, errors occurring in the method of the present invention of FIG. 14 to errors occurring in the conventional method of FIG. 13 is 4.46% for red, 15.6% for green, and 4.72% for blue, which means that errors in the method according to an exemplary embodiment of the present invention occur much less than in the conventional method. In this case, errors are calculated by Equation 2, in which “a” represents color data obtained by each method, “c” represents color data of an original image shown in FIG. 12, and “m” and “n” represent positions.

$$Sa = {\sum }_{m = 1}^{M} {\sum }_{n = m}^{N} {( a ( n , m ) - c ( n , m ) )}^{2} \qquad Equation 2$$

Therefore, when the image sensing method using the image sensor according to an exemplary embodiment of the present invention is employed, the quality of a sensed image is improved as compared with the prior art, thereby sensing an image with an improved resolution.

As described above, the image sensor and image sensing method according to an exemplary embodiment of the present invention have the following effects.

The image sensor for improving image quality according to an exemplary embodiment of the present invention uses a color filter location change manner while using the conventional photoelectric conversion semiconductor device and color filter array without change in size thereof, so that it is possible to improve image quality of a sensed image without cost increase and/or degradation in sensing performance.

Also, the image sensing method according to an exemplary embodiment of the present invention senses an equal image with each of color filters having different colors while moving a movable color filter array in a unit of pixel, thereby securing image data for each color, so that it is possible to easily improve the quality of an image sensed by the image sensor.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An image sensor for improving image quality, the image sensor sensing an image through photoelectric conversion, the image sensor comprising:
a scanner unit movable on a plane;
a color filter array fixed on the scanner unit; and
a photoelectric conversion semiconductor device including a plurality of pixels aligned beneath the color filter array.

2. The image sensor as claimed in claim 1, further comprising a microlens array formed on top of the color filter array so as to correspond to the pixels.

3. The image sensor as claimed in claim 1, wherein the scanner unit is fixed on an end of the color filter array so as to move with the color filter array.

4. The image sensor as claimed in claim 1, wherein the scanner unit moves interval by interval between the pixels.

5. The image sensor as claimed in claim 1, wherein the scanner unit moves only in a horizontal or vertical direction with respect to a transverse direction in which the pixels are aligned.

6. The image sensor as claimed in claim 1, wherein the color filter array comprises color filters having different colors, in which the color filters are aligned in a pattern of stripes.

7. An image sensing method using an image sensor for sensing an image through photoelectric conversion, the method comprising:
(a) sensing, via a photoelectric conversion semiconductor device, light incident through a color filter array which is stationary;
(b) storing data of an image sensed by the photoelectric conversion semiconductor device;
(c) moving the color filter array on a plane by the scanner unit;
(d) sensing, via the photoelectric conversion semiconductor device, light incident through the color filter array which is stopped after moving;
(e) storing data of another image sensed by the photoelectric conversion semiconductor device;
(f) repeating steps (c) to (e); and
(g) comparing and analyzing the data stored according to movement of the color filter array so as to obtain data of a resultant image having improved image quality.

8. The method as claimed in claim 7, wherein the color filter array moves interval by interval between pixels of the photoelectric conversion semiconductor device.

9. The method as claimed in claim 7, wherein the color filter array moves in a horizontal or vertical direction on the plane, with respect to a transverse direction in which the pixels are aligned.

10. The method as claimed in claim 7, wherein the color filter array includes filters of different colors, in which the filters have a pattern of stripes, and the color filter array moves only in a direction perpendicular to the pattern of stripes.
